(19) United States
(12) Patent Application Publication
(10) Pub. No.: US 2024/0376874 A1
(43) Pub. Date: Nov. 14, 2024

(54) SUPER HIGH FREQUENCY PROPULSOR (FARADAY DRIVE)

(71) Applicant: Corey HENDRIKS, Boulder Creek, CA (US)

(72) Inventor: Corey HENDRIKS, Boulder Creek, CA (US)

(21) Appl. No.: 18/608,914

(22) Filed: Mar. 18, 2024

Related U.S. Application Data
(60) Provisional application No. 63/490,674, filed on Mar. 16, 2023.

(51) Int. Cl. F03H 1/00

(52) U.S. Cl. CPC F03H 1/0075

(57) ABSTRACT

A system and method are disclosed for generating asymmetric net force in a closed system using Super High Frequency (SHF) electromagnetic induction (at least at 3 gHz) and magnetic metamaterials. The system includes an engine or propulsor. The propulsor includes a propagative electromagnetic element or an emitter coil, a collective electromagnetic element or receptor ring and a coaxial magnetic core. The method involves energizing the electromagnetic emitter coil at a frequency of at least 3 gHz to induce the receptor ring element in a manner that causes a magnetomechanical action through internal heating (Joule Heating) of the receptor ring atomic substrate (via SHF EMF), The super high frequency propulsor uses one of, a combination of, or all of, the unique EM activity such as: Magnetostriction, SHF Electromotive Force and Magnetic Field Asymmetry in this specific Coil-Ring with Magnetic Core system in SHF (>3 GHZ) to generate a usable magnetomechanical force.

### CROSS REFERENCE TO RELATED APPLICATION

The application claims the benefit of U.S. Provisional Application Ser. No. 63/490,674 filed on Mar. 16, 2023 by Corey Hendriks, the entire disclosure of which is incorporated herein by reference.

### FIELD

The present disclosure relates generally to the field of propulsion, and more specifically, utilization of electromagnetic fields, electromagnetic induction, magnetostriction, electromotive force and Super High Frequency (SHF) Electromagnetic systems (>3 GHZ).

### BACKGROUND

The activity of magnetism is predictable and evident and has been utilized for decades in a variety of sectors such as transportation (Magnetic Levitation Trains i.e.: “The Magnetic River” concept) munitions such as so-called “Railguns” or “Mass Driver” ballistic weapons, MRI imaging devices integral to modern medicine and others. The vast potential for greater practical utilization of EM phenomena and Magnetism has only begun to be realized and therefore a continued visitation of the phenomena with modern ancillary technologies and more acute examination and simulation may help expand the implementation of these types of devices.

Another challenge lies in managing the energy requirements and efficiency of this propulsion system. Generating electromagnetic pulses can demand significant power, and optimizing energy usage while ensuring the engine's stability and reliability is a complex task. Additionally, mitigating electromagnetic interference is a focus area. These engines can inadvertently disrupt nearby electronic devices, so minimizing interference with surrounding equipment or communication systems is a challenge during development. Development of effective Alloys and/or Magnetic Metamaterials to maximize the produced Magnetomechanical effects of the Coil-Ring system is also a principle technical objective. Furthermore, engineering components that can withstand high-intensity electromagnetic fields and rapid pulse generation without degradation or failure adds complexity to the design process. Lastly, achieving a balance between the complexity of the system and its practicality in real-world applications poses a challenge. Therefore, what is needed is a system and method that are cost-effective solutions without compromising functionality and performance that are essential for the widespread adoption of super high frequency propulsors.

### SUMMARY

In accordance with the various aspects and embodiment of the invention, a system and method are disclosed for cost-effective and performance driven results using super high frequency propulsors. Central to the operational mechanics of the system or apparatus is Electromotive Force, Magnetostriction, Magnetic Eddy Currents and other phenomena in the SHF range. The EMF is the result of fluctuating magnetic fields as they pass through conductive material (in our case, the Ring-Coil Thruster). The super high frequency propulsors uses this Magnetic-Physical interaction to generate a mechanical force. This orchestrated alignment of Electromagnetic Induction may generate a controllable and directed origin of this thrust, which necessitates solely the input of electrical current to function.

A super high frequency propulsor is a technological system designed to generate and control SHF electromagnetic pulses in a rhythmic or patterned sequence. These engines harness the power of EM phenomena such as Magnetostriction and other extraordinary Magnetomechanical activity in SHF range. Devices utilizing these principles are currently in widespread use in various applications such as magnetic actuators and sensors, material sciences, experimental research settings and now potentially propulsion. These SHF Propulsors operate by manipulating the principle of Electromagnetic Induction in a specific Coil-Ring with metallic Core configuration operating in SHF range to exploit the associated magnetic phenomena and exhibited magnetomechanical force. Developing super high frequency propulsors units involves various challenges. One significant challenge is achieving precise control and synchronization of electromagnetic pulses within the desired frequency range. Designing systems that can reliably generate and modulate these pulses while maintaining accuracy and consistency poses a technical hurdle.

Electromagnetic systems present a distinctive dynamism by enabling the control of their electromagnetic (EM) activity through the introduction of electrical current, a process known as induction. A precisely coordinated interplay between SHF induction of an “Emitter Coil” and a “Receptor Ring” in a coaxial configuration can generate Magnetomechanical Force in the receptor ring and other effects. The effect of Magnetostriction is another principle contributor to thrust in this system. Magnetostriction is the property of physical compounds that change shape under applied magnetic fields. One electromagnetic coil initiates pulses to propagate EM fields and waves, while its counterpart receptor component responds by intercepting and capturing the non-instantaneous transmission of Magnetic Flux. The receptor ring atomic structure changes dimension in response to the applied magnetic fields (magnetostriction) and the internal structure of the Ring heats through Joule Heating. In theory, the utilization of anisotropic electromagnetic fields and magnetic metamaterials may also lend to greater effectiveness of a SHF pulsed EM device that benefits from unique effects of SHF Electromagnetic Induction.

The principle behind SHF Electromagnetism as thrust is the utilization of fluctuating magnetic fields and unique materials to generate asymmetric magnetomechanical force in a closed loop. The SHF Propulsor exploits one of, a combination of, or all of the aforementioned EM effects of SHF systems. Present technology only permits weak EMF thrust values (likely on the order of MicroNewtons). This generation of asymmetrical force is possible by virtue of the constancy of light, SHF EM activity and advanced material sciences that can enable exotic concepts such as magnetic diodes etc. At the extremely small timescales and distances used in the SHF Propulsor we must consult mathematics that describe retarded regime and transient charges owing to relativistic effects and electronic activity.

Using the series of Jefimenko's equations in retarded regime as well as the standard suite of electromagnetic equations (shown below) to inform the correct construction of a device of specific size and intended utility—this system can be honed to the optimal cadence of the electrical phasing to establish practical, reliable operation. This system best exploits the commonplace effects of magnetostriction and EMF phenomena as a method of spacecraft propulsion. The prospect of a mechanism of generating thrust that requires only electrical current and the exploitation of magnetic phenomena could revolutionize spaceflight and space-enterprise, industry, transportation, national-defense, and lead to the innovation of other as of yet unknown technologies such as magnetic actuators and sensors. A functional design for propellant-less spacecraft may convey economic, social and existential benefit.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a side view of the basic 10 cm emitter coil/receptor ring coaxial thruster configuration. Associated variables are shown.

FIG. 2 is a 3D, side, and top view of the basic SHF Propulsor with a metallic magnetic-moderating core in accordance with the various aspects and embodiments of the invention.

FIG. 3 is a 3D, side, and top view of the basic SHF Propulsor with a metallic magnetic-moderating core. The entire EMF unit is contained within Magnetic insulation in accordance with the various aspects and embodiments of the invention.

FIG. 4 is a graph of calculated instantaneous net force values (in Newtons) for Emitter-Ring configurations of different radii at different distances between the electromagnetic elements in accordance with the various aspects and embodiments of the invention.

FIG. 5 shows multiples views of a hexagonal super high frequency propulsor affixed in a nacelle array in accordance with the various aspects and embodiments of the invention.

### DETAILED DESCRIPTION

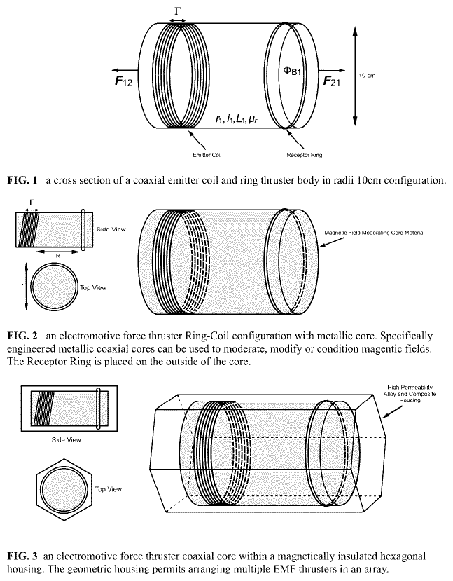

FIGS. 1-3 illustrate example systems and methods of utilizing a SHF for propulsion in accordance with the various aspects and embodiments of the invention. Propulsor can be used in many applications, including as a propulsion system for spacecraft. Within a module secured to a shared framework, two electromagnetic components are positioned coaxially. The specific placement of the emitter coil and receptor ring, contingent upon their size and strength and the device's intended use, allows for a coordinated phase. In accordance with the various aspects and embodiments of the invention, the SHF phase involves the electric pulsing, which may be referred to as energizing or activating, of the emitter coil causes the generation or production or emission or “propagation” of a magnetic field (known to travel at the Speed of Light). In accordance with the various aspects and embodiments of the invention, the propagation magnetic field is conditioned by a specialized core and “collected” by the ferromagnetic receptor ring. Consequently, via magnetostriction, internal heating of the receptor ring through Joule Heating, exhibited Magnetic Eddy Currents, and a magnetic diode principle, a weak asymmetric magneto mechanical force can be produced. This asymmetry is a result in part, of the nature of a transient and retarded regime in SHF.

Effectively, the receptor ring functions akin to a “net,” gathering the discrete quantity of electromagnetic energy traversing the space between the components. Advanced methods and materials in the core and/or ring enables the ability to direct the magnetic fields in only one direction (Magnetic Diode). The number of actuator applications based on magnetostrictive materials, mainly Terfenol-D, is continuously increasing as a consequence of the high energy density, high force, broad frequency bandwidth, and fast response that these materials provide. Even though the cost of Terfenol-D is high at present, the range of applications is likely to continue increasing as manufacturing techniques are perfected and prices decline.

The interaction of SHF magnetic flux and ferromagnetic material generates the anticipated force characteristic of magnetostrictive, electromotive, magnetic phenomena. After more thorough and acute examination we find that subtle microscopic Net forces exhibit in this thruster design and may potentially be exploited.

Thorough analysis of magnetic phenomena contributes to this system for utilizing consistently exhibited, omnipresent, and predictable magnetomechanical force. The device does not necessitate focused exploration of new scientific, mathematical, or technological domains; rather, it relies on the integration of existing, suitable components and accurate assembly. It may be emphasized that the device's functionality relies on the established physical forces inherent in the universe; it does not operate by opposing or circumventing these forces in any manner. The device does not violate Newtons Third Law. The underlying operational principles of the device are rooted in fundamental and unchanging physical properties and conditions such as:

The Finite Speed of Light: The speed of light is a constant value denoted by “c” used widely as: 3.0×10⁸ m/s.

This value is used to determine the distance between the emitter coil element and the receptor ring. The propagated magnetic fields travel at “c” and recall that at more pedestrian scales the Speed of Light is 1 foot per 1 ns. Initial embodiments of the SHF Propulsor will be relatively small; likely on the order of centimeters in radius and in length. The finite and constant speed of light is a bedrock of the principle of electromagnetic induction and is one of the fundamental properties of physics that makes possible this method.

### Induction of The Electromagnetic Components (L)

This value is used for calculating the SHF phase due to the extremely brief moment for exploiting the magnetic flux. Several equations are used here: Faraday's Law of EM Induction, Lenz's Law, Ohm's Law and others. It may be assumed that the objective is the most rapid cadence possible measured in Hz. Each Electromagnetic emitter component benefits from multiple, equidistant capacitors if needed, to achieve the most rapid and complete energization of the Emitter Coil. In accordance with the various aspects and embodiments of the present invention, the system facilitates massively powerful electromagnet pulses on the order of nanoseconds. As noted herein, capacitor banks can be coupled to the emitter coil and positioned within the housing as appropriate.

The impact of the local gravitational force is a critical factor to acknowledge. In environments where gravitational forces are minimal or absent, such as in space, the device can allocate its energy exclusively to directional control. In space, even a weak source of thrust can prove invaluable. Initial embodiments of super high frequency propulsors will most effectively be employed for station-keeping propulsion as the thrust values may be relatively low.

### Electromagnetic Wave And Field Strength

Applying essential equations to ascertain the magnitude of electromagnetic (EM) fields and waves guides both the functionality and construction of the device, along with all telemetry data analysis. Through the modulation of field strength and phasing the operator can achieve smooth, dependable, and secure operation. Maxwell's Equations, aiding in the determination of EM Wave Energy Intensity by utilizing the Permeability and Permittivity of Free Space, can familiarize engineers with the scale of forces within a device of specified dimensions if functional parameters are not yet established. These are:

$${I}_{AVERAGE} = \frac{{E}_{0} {B}_{0}}{2 {μ}_{0}} \qquad Eq . 1$$

$$Where : {I}_{AVERAGE} = Intensityin \frac{Watts}{{m}^{2}} Average .$$

$${E}_{0} {B}_{0} = Themaximumoftheelectricalfieldandmagneticfiledsrespectively .$$

$${μ}_{0} = PermeabilityofFreeSpaceor “ Themagneticconstant ”$$

$${I}_{AVERAGE} = \frac{{ce}_{0} {E}_{0}^{2}}{2} . \qquad Eq . 2$$

$$Where : c = TheSpeedofLight 3. \times 1 {0}^{8} \frac{m}{s}$$

$${e}_{0} = Thepermittivityoffreespaceor “ TheElectricalConstant ”$$

Recognizing that Magnetic Fields (“B-Fields”) in SHF Flux and associated phenomena predominantly contribute to magneto mechanical force generation, Ohm's Law may be employed if required in the process.

$$A = \frac{V}{Ω} \qquad Eq . 3$$

$$Where : A = Amperes , V = Voltage , and Ω = Ohms .$$

To ascertain unfamiliar parameters (wherein the values for A and V are typically known due to the determined level of Voltage regulated by the Computer Control Unit and Power Supply), the approach involves utilizing Maxwell's Equations to calculate the strengths of Electrical and Magnetic Fields. Once the characteristics of these Fields are established, analysis of the relationship between these distinct fields may be performed.

$$c = \frac{E}{B} \qquad Eq . 4$$

$$Where : E = Electrical Field Strength ,$$

$$B = Magnetic Field Strength , and$$

$$c = Speed of Light .$$

Lenz' Law is integral here: “The direction of the induced EMF (and hence the induced current) in a conductor is always such as to oppose the change in magnetic flux that produced it.” Mathematically, Lenz's Law can be expressed using the following equation:

$$ε = - \frac{Δ Φ}{Δ t} \qquad \begin{matrix}ε is the induced EMF ( electromotive force ) , \\ ΔΦ is the change in magnetic flux , and \\ Δ t is the change in time .\end{matrix}$$

Owing to the astoundingly dynamic environment of electromagnetic fields in SHF range, retarded regime and with transient charges we consult Jefimenko's equations in retarded regime. The Jefimenko equations give the exact expressions of retarded electric E^{→}(^{→}x,t) and magnetic B^{→}(^{→}x,t) fields in space and time created by a transient (time dependent) current distribution. They are generally written as follows:

$$\vec{E} ( \vec{x} , t ) = \frac{1}{4 π {ε}_{0}} \int {d}^{3} {x}^{′} \{ {\frac{\vec{R}}{{R}^{3}} [ α ( \vec{{x}^{′}} , {t}^{′} ) ]}_{ret} + {\frac{\vec{R}}{c {R}^{2}} [ \frac{\partial α ( \vec{{x}^{′}} , {t}^{′} )}{\partial {t}^{′}} ]}_{ret} - {\frac{1}{{c}^{2} {R}^{2}} [ \frac{\partial \vec{J} ( \vec{{x}^{′}} , {t}^{′} )}{\partial {t}^{′}} ]}_{ret} \} \qquad ( 1 )$$

$$\vec{B} ( \vec{x} , t ) = \frac{{μ}_{0}}{4 π} \int {d}^{3} {x}^{′} \{ {[ \vec{J} ( \vec{{x}^{′}} , {t}^{′} ) ]}_{ret} ∧ \frac{\vec{R}}{{R}^{3}} + {[ \frac{\partial \vec{J} ( \vec{{x}^{′}} , {t}^{′} )}{\partial {t}^{′}} ]}_{ret} ∧ \frac{\vec{R}}{c {R}^{2}} \} \qquad ( 2 )$$

$$\{ \begin{matrix}\vec{R} = ( \vert ρ \vert - r cos θ ) {\vec{u}}_{x} - r sin θ {\vec{u}}_{y} + z {\vec{u}}_{z} \\ \vec{J} ( \vec{{x}^{′}} , {t}^{′} ) {d}^{3} {x}^{′} = J ( \vec{{x}^{′}} , {t}^{′} ) dS \vec{d l} = i ( \vec{{x}^{′}} , {t}^{′} ) {dl}^{′} {\vec{u}}_{θ}\end{matrix} \qquad ( 3 )$$

where ε0 and μ0 are respectively the electric and magnetic constants,
c is the light velocity,
α the charge density and
J^{→} the current density.
R(|R^{→}|=|^{→}x−x^{→}′|) is the distance separating the current sources and observation points while (x^{→}″, t′=t−|^{→}x−x^{→}′|/c) denotes the (retarded) coordinates of the current source where the electromagnetic waves traveling at light speed are created.

The particular case of a ring with a transient current i is analyzed using the cylindrical coordinates (z, θ, p) where r is the ring radius, S the ring section and dl the unit length of the ring. We define the vector R^{→}: since the problem is cylindrical, the integration can be done on one plane passing through the z axis. The x axis is taken as integration axis. Then the vector R^{→} points from the integration element dl to the plane Oxz located at (ρ,z). As there is no charge density in the ring (α=0) and injecting Eq. (3) into Eqs. (1) and (2), the analytical electromagnetic field in transient regime created by a ring is written in cylindrical coordinates:

$${E}_{θ} ( ρ , z , t ) = - \frac{1}{4 {πε}_{0} {c}^{2}} \frac{1}{2 \vert ρ \vert} \int {[ \frac{\partial i ( \vec{{x}^{′}} , {t}^{′} )}{\partial {t}^{′}} ]}_{ret} \frac{d θ}{( a - cos θ )} \qquad ( 4 )$$

$${B}_{ρ} ( ρ , z , t ) = \frac{{μ}_{0} rz}{4 π} ( \frac{1}{{( 2 r \vert ρ \vert )}^{3 / 2}} {\int }_{- π}^{π} {[ i ( {x}^{′} , {t}^{′} ) ]}_{ret} \frac{cos θ d {θ}^{′}}{{( a - cos θ )}^{3 / 2}} + \frac{1}{2 cr \vert ρ \vert} {\int }_{- π}^{π} {[ \frac{\partial i ( {x}^{′} , {t}^{′} )}{\partial {t}^{′}} ]}_{ret} \frac{cos θ d {θ}^{′}}{a - cos θ} ) \qquad ( 5 )$$

$${B}_{z} ( ρ , z , t ) = \frac{{μ}_{0} r}{4 π} ( \frac{1}{{( 2 r \vert ρ \vert )}^{3 / 2}} ( {\int }_{- π}^{π} {[ i ( {x}^{′} , {t}^{′} ) ]}_{ret} \frac{r d {θ}^{′}}{{( a - cos θ )}^{3 / 2}} - {\int }_{- π}^{π} {[ i ( {x}^{′} , {t}^{′} ) ]}_{ret} \frac{\vert ρ \vert cos θ d {θ}^{′}}{{( a - cos θ )}^{3 / 2}} ) + \frac{1}{2 cr \vert ρ \vert} ( {\int }_{- π}^{π} {[ \frac{\partial i ( {x}^{′} , {t}^{′} )}{\partial {t}^{′}} ]}_{ret} \frac{r d {θ}^{′}}{a - cos θ} - {\int }_{- π}^{π} {[ \frac{\partial i ( {x}^{′} , {t}^{′} )}{\partial {t}^{′}} ]}_{ret} \frac{\vert ρ \vert cos θ d {θ}^{′}}{a - cos θ} ) ) \qquad ( 6 )$$

$$with a ≡ \frac{{ρ}^{2} + {z}^{2} + {r}^{2}}{2 \vert ρ \vert r} .$$

Equations (4)-(6) are the generalized equations of Jefimenko for a single ring with transient current. To confirm the consistence of Eqs. (4)-(6), the analytical Biot-Savart expression of the magnetic field along the z axis of the ring with a DC current Bz(ρ=0)=μ0ir2/[2(r2+z2)3/2] should be recovered from Eq. (6) by fixing the boundary condition ∂i/∂t=0 and ρ→0. The numerical calculations of elliptical functions were done with Mathematica 6. The good agreement between the ρ→0 known analytical expression and the calculated one is a first validation of Eq. (6). As an additional check, far from the coil the expression of the fields should approach those of a radiating magnetic dipole. For that, define the magnetic dipole moment of the ring m^{→}=πr2iu^{→}z. The static magnetic dipole assumes a constant current ∂i/∂t=0 and ^{→-}a negligible ring radius R^{→-}>>r. With the later conditions, Eqs. (5) and (6) should be identical with those reported in literature Bx=μ03mxz/(4π(x2+z2)5/2) and Bz=μθm(2z2−x2)/(4π(x2+z2)5/2) [15]. Because of cylindrical symmetry, the radial components are equal (Bx=By). The good agreement between analytical and numerical calculations is a second validation of Eqs. (5) and (6). Further on, a force study gives the estimation of net thrust between two coaxial rings.

This approach necessitates only electrical current, which can be conveniently supplied by modern power sources such as a 110 Watt Multi-mission Radioisotopic Thermoelectric Generator or Photovoltaic Cells. Further, advances in engineering of magnetic Metamaterials may increase the power and efficiency of the EMF and magnetomechanical force in systems with coaxial cores.

Magnetostriction: is a phenomenon where materials undergo mechanical changes in response to a magnetic field. While it is a real and studied effect, it is important to note that conventional magnetostriction, as understood in physics, typically involves small-scale deformations at the atomic or molecular level. This phenomenon is often exploited in sensors and actuators. The challenge arises when attempting to extrapolate magnetorestriction to generate significant thrust or propulsion at larger scales, especially in the context of high-frequency electromagnetic fields. Conventional understanding suggests that the forces generated through magnetorestriction at the atomic scale are relatively small. The Magnetostrictive Coefficient is derived thusly using the following magnetostrictive coefficient formula, wherein, if the material is under compression due to the magnetic field, then the magnetostrictive coefficient will be negative:

$$λ = Δ L / {L}_{0}$$

where λ: Magnetostrictive coefficient
ΔL: Change in length of the material
Lₒ: Original length of the material

FIG. 1 illustrates the basic Emitter Coil-receptor ring configuration of an SHF Propulsor in a 10 cm Radii embodiment.

FIG. 2 illustrates the SHF Propulsor with an added ferromagnetic metallic core. Such cores may be engineered of different alloys and even magnetic meta-materials which can modify the active magnetic fields to increase the effectiveness of the SHF Propulsor. Specialized cores can be used to lower the working frequency of Coil-Ring systems and even enable generation of extreme Magnetic field asymmetry. The receptor ring is placed outside the metallic core.

FIG. 3 illustrates the SHF Propulsor encased within a geometric, magnetically insulated housing. The housing is composed of high permeability alloy and/or similar material which serves to encapsulate and insulate the super high frequency propulsors unit from the electromagnetic activity of neighboring electronic components or other super high frequency propulsors units.

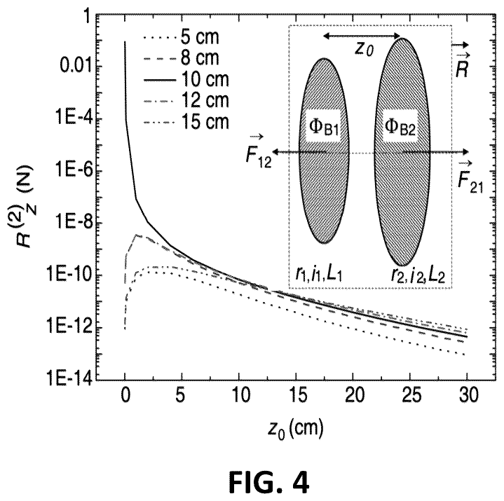

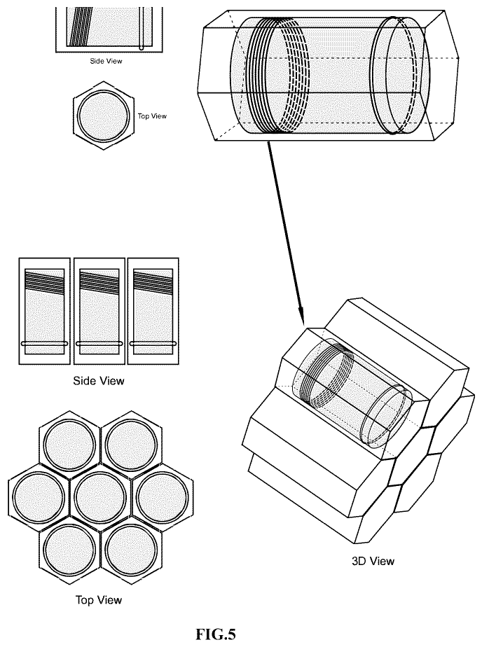

Referring now to FIG. 4, a table of numerically calculated instantaneous net force R⁽²⁾ (in N) for a system of emitter-receptor vs. their separating distance z₀ and for different receptor radius r₂ is shown in accordance with the various aspects and embodiment of the invention. The emitter coilradius was r₁=10 cm, a receptor ring inductance L₂=10 mH, a magnetic core with z_{μr}=10 cm. The current i₁ was applied with a ramp of 50 mA/ns. The inset shows the interaction of two coaxial emitter coil (left) and receptor rings (right). ϕ_{B1}, ϕ_{B2} are the magnetic fluxes, F^{→}₂₁, F^{→}₁₂ the Laplace force for the receptor and emitter rings respectively. The outer dashed box represents the system of jointed rings with an instantaneous resultant R^{→}=F^{→}₁₂+F^{→}₂₁. The inset does not show the magnetic core for simplicity.

Referring now to FIG. 5, a group of hexagonal propulsors are arranged in a nacelle array of nacelle array in accordance with the various findings of aspects and embodiment of the present invention.

### Magnetostriction

One advantage of magnetostriction actuators over other types is that their driving voltages can be very low, which is useful in medical applications, and in general simplifies the amplifier design. When a magnetostrictive material is subjected to an alternating magnetic field, the material vibrates at twice the frequency of that field, and this magnetostrictive vibration is the major source of the humming sound emitted by transformers. Conversely, if a magnetostrictive material is subjected to a mechanical stress, its magnetic permeability will change because of the inverse magnetostrictive effect. If, at the same time the material is subjected to an alternating magnetic field produced by a coil with an alternating current, the magnetic flux density pattern will also change as a result of the change in magnetic permeability. This effect can be detected in a separate “pick up” coil where the alternating magnetic flux will induce an alternating emf whose magnitude varies with the magnetic permeability of the material. This effect is exploited in magnetostrictive transducers, which are capable of converting electrical energy into mechanical energy.

Below is a table of magnetostrictive materials and their respective magnetostrictive coefficients.

| Material | $\frac{3}{2} {λ}_{\text{?}} ( \times {10}^{- 6} )$ | ρ(g/cm⁸) | [symbol] | [symbol] | E (GPa) | k |
|---|---|---|---|---|---|---|
| Fe | −14 (8) | 7.88 (14) | 2.15 (14) | 770 (14) | 285 (14) | |
| Ni | −50 (14) | 8.9 (14) | 0.61 (14) | 368 (14) | 210 (1) | 0.31 (8) |
| Co | −98 (14) | 8.9 (14) | 1.79 (14) | 1120 (14) | 210 (1) | |
| 50% Co-50% Fe | 87 (2) | 8.25 (8) | 2.45 (76) | 500 (14) | | 0.35 (8) |
| 50% Ni-50% Fe | 19 (2) | | 1.60 (76) | 500 (14) | | |
| TbFe₂ | 2630 (8) | 9.1 (14) | 1.1 (2) | 428 (8) | | 0.35 (8) |
| Th | 3000 (−196° C.) (36) | 8.33 (14) | | −48 (13) | 55.7 (1) | |
| Dy | 6000 (−196° C.) (86) | 8.56 (14) | | −184 (1) | 61.4 (1) | |
| Terfenol-D | 1620 (8) | 9.25 | 1.0 | 380 (76) | 110 (77) | 0.77 (78) |
| Tb_{0.6}Dy_{0.4} | 6000 (−196° C.) (36) | | | | | |
| Metglas 2605SC | 60 (36) | 7.32 (2) | 1.65 (76) | 370 (2) | 25-200 (2) | 0.92 (1) |

[symbol]

Unless otherwise specified, all measurements were performed at room temperature. [symbol]
indicates data missing or illegible when filed

The housing may be made of a non-conductive material including the combination of carbon fiber, a high permeability alloy, and Mu metal. Mu metal, also known as Mu-metal, is a specialized alloy primarily composed of nickel, iron, copper, and molybdenum, with high permeability to magnetic fields. It exhibits excellent magnetic shielding properties, specifically designed to divert or attenuate magnetic fields. The unique composition and structure of Mu metal enable it to redirect or absorb magnetic flux, making it particularly useful in applications where the containment or reduction of magnetic fields is necessary. This material is often utilized in various industries and devices such as electronics, scientific instruments, electrical transformers, shielding sensitive equipment from magnetic interference, and in manufacturing components for magnetic field measurement and control. The effectiveness of Mu metal in reducing magnetic field interference makes it a valuable resource in applications where precise control or isolation of magnetic fields is realized.

### Charged Particle Motion

In the thruster design, electromagnetic activity, particularly induced by the emitter coil, creates a dynamic electromagnetic field within the system.

### Receptor Ring Interaction:

As the charged particles within the receptor ring element interact with this electromagnetic field, they experience a force known as the Lorentz force.

### Force Generation:

The Lorentz force acts perpendicular to both the direction of the charged particle's velocity and the direction of the magnetic field. This interaction results in a force that contributes to the magnetomechanical action, ultimately leading to propulsion.

### Enhancement of Asymmetric Net Force:

By leveraging the Lorentz force in conjunction with other mechanisms like Magnetostriction, Joule Heating, and magnetic field diode principles, the thruster design can enhance the asymmetric net force generation, thereby improving its efficiency and effectiveness as a propulsion system.

In accordance with the various aspects and embodiments of the invention, the system involves various electromagnetic principles and phenomena. The Lorentz force likely plays a crucial role in driving the propulsion mechanism forward. The Lorentz force equation describes the force experienced by a charged particle moving through an electromagnetic field. It's given by the following equation:

$${F}^{\to } = q ( {E}^{\to } + {v}^{\to } \times {B}^{\to } ) F = q ( E + v \times B )$$

Where:
F^{→} and F is the force experienced by the charged particle,
q is the charge of the particle,
E^{→} and E is the electric field vector,
v^{→} v is the velocity vector of the charged particle,
B^{→}<span class=“mord mathnormal” style=“border: 0px solid; box-sizing: border-box; -tw-border-spacing-x: 0; -tw-border-spacing-y: 0; -tw-translate-x: 0; -tw-translate-y: 0; -tw-rotate: 0; -tw-skew-x: 0; -tw-skew-y: 0; -tw-scale-x: 1; -tw-scale-y: 1; -tw-pan-x:; -tw-pan-y:; -tw-pinch-zoom:; -tw-scroll-snap-strictness: proximity; -tw-gradient-from-position:; -tw-gradient-via-position:; -tw-gradient-to-position:; -tw-ordinal:; -tw-slashed-zero:; -tw-numeric-figure:; -tw-numeric-spacing:; -tw-numeric-fraction:; -tw-ring-inset:; -tw-ring-offset-width: 0px; -tw-ring-offset-color: #fff; -tw-ring-color: rgba

Several examples of high permeability alloys include materials like Mu Metal, Permalloy, and Supermalloy which have low Magnetostrictive coefficients. Mu Metal is composed mainly of nickel, iron, copper, and molybdenum, offering remarkable magnetic permeability ideal for magnetic shielding in sensitive electronics and magnetic field control systems. Permalloy, primarily made of nickel and iron in various proportions, exhibits excellent magnetic properties, serving in transformers, magnetic amplifiers, and electromagnetic shielding due to its high permeability and low coercivity. Supermalloy, an alloy of nickel, iron, and molybdenum, possesses extremely high magnetic permeability, making it valuable in shielding applications requiring exceptional magnetic field attenuation, particularly in scientific instruments and high-precision equipment. These alloys are engineered to provide specific magnetic characteristics and find widespread use in industries such as electronics, telecommunications, aerospace, and scientific research where magnetic field control is needed.

Furthermore, recent advances in meta materials production can potentially enable extreme magnetic field asymmetry akin to a magnetic field diode and lower the working frequency.

This method enables the generation of magnetomechanical force with precise timing and duration, allowing for various applications in fields such as telecommunications, defense, and scientific research. The number of actuator applications based on magnetostrictive materials, mainly Terfenol-D, is continuously increasing as a consequence of the high energy density, high force, broad frequency bandwidth, and fast response that these materials provide. Even though the cost of Terfenol-D is high at present, the range of applications is likely to continue increasing as manufacturing techniques are perfected and prices decline.

In accordance with the various aspects and embodiments of the invention, the propulsor uses a gimbal. As referenced herein, a gimbal is a pivoted support that permits rotation of an object about an axis. A set of three gimbals, one mounted on the other with orthogonal pivot axes, may be used to allow an object mounted on the innermost gimbal to remain independent of the rotation of its support (e.g. vertical in the first animation). For a non-limiting example, the propulsor includes gimbals to help keep the components upright with respect to the horizon or horizontal despite a support structures pitching and rolling.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below.

All publications, as shown in the Appendix, and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

It is therefore evident that the particular embodiments disclosed above may be altered or modified and all such variations are considered within the scope of the disclosed subject matter. Accordingly, the protection sought herein is as set forth in the claims below.

What is claimed is:

1. A super high frequency propulsor, comprising:
an emitter coil;
a receptor ring;
a magnetic coaxial core, wherein the magnetic coaxial core is coupled to and positions the emitter coil opposite the receptor ring; and
a housing made of a non-conductive material, wherein the housing retains the magnetic coaxial core, the emitter coil, and the receptor ring.

2. The super high frequency propulsor of claim 1, wherein the emitter coil is energized resulting in induction of the receptor ring thereby generating an electromotive force in the receptor ring.

3. The super high frequency propulsor of claim 1, further comprising a power source that is a radioisotopic thermoelectric generator.

4. The super high frequency propulsor of claim 1 further comprising one or more modules affixed into an array and positioned within the housing.

5. The super high frequency propulsor of claim 4, wherein the one or more modules form at least one of a hexagonal nacelle array and other geometric nacelle array.

6. The super high frequency propulsor of claim 5 further comprising a radiosotopic thermoelectric generator centrally located within the hexagonal nacelle array.

7. The super high frequency propulsor of claim 1, wherein the emitter coil and receptor ring are electromagnetic elements.

8. The super high frequency propulsor of claim 7, wherein the emitter coil and the receptor ring are substantially circular in shape and attached to the magnetic coaxial core.

9. The super high frequency propulsor of claim 7, wherein the emitter coil and the receptor ring are capable of magnetic anisotropic.

10. The super high frequency propulsor of claim 1 further comprising one or more capacitor banks connected to the housing.

11. The super high frequency propulsor of claim 1, wherein the non-conductive material of the housing comprises:
a layer of mu metal;
a high permeability alloy disposed on the layer of mu metal; and
a layer of carbon fiber disposed at surface of the high permeability alloy.

12. A propulsor comprising:
a first electromagnetic coil;
a second electromagnetic ring;
a magnetic coaxial core;
a support structure positioning the first electromagnetic coil opposite the second electromagnetic ring;
a power source to energize the coil;
a housing composed of a non-conductive material, the housing to retain the first electromagnetic coil and the second electromagnetic coil and the magnetic coaxial core and support structure; and
a gimbal assembly, the gimbal assembly connected to an outer wall of the housing.

13. The propulsor of claim 12, wherein the power source is a radioisotopic thermoelectric generator.

14. The propulsor of claim 12, further comprising a plurality of housings forming a hexagonal nacelle array.

15. The propulsor of claim 14 further comprising one or more capacitor banks connected to the housing.

16. The propulsor of claim 14, wherein the non-conductive material includes:
a layer of mu metal;
a high permeability alloy disposed on the layer of mu metal; and
a layer of carbon fiber disposed on a surface of the high permeability alloy.

17. A super high frequency propulsor comprising:
an emitter coil composed of magnetic metamaterial;
a receptor ring composed of magnetic metamaterial;
a magnetic coaxial core composed of magnetic metamaterial, wherein the core positions the emitter coil opposite the receptor ring; and
a housing composed of a non-conductive material, the housing to retain the emitter coil and the receptor ring and the core,
wherein the coil is energized using super high frequency energy.

18. The super high frequency propulsor of claim 17, wherein as the emitter coil is energized resulting in induction of the receptor ring thereby generating an electromotive force in the receptor ring such that a magnetic flux interacts with physical atomic structures of the magnetic core permits unidirectional magnetic field activity and within the receptor ring causing at least one of: joule heating, magnetostriction, and magnetomechaincal force.

19. The super high frequency propulsor of claim 18, wherein the emitter coil is de-energizing.
